(19) United States
(12) Patent Application Publication
(10) Pub. No.: US 2026/0230869 A1
(43) Pub. Date: Aug. 6, 2026

(54) EVENT DETECTION FOR CHANNEL STATE INFORMATION COMPRESSION

(71) Applicant: Apple Inc., Cupertino, CA (US)

(72) Inventors: Konstantinos Sarrigeorgidis, Los Gatos, CA (US); Yang Tang, San Jose, CA (US); Jie Cui, San Jose, CA (US); Xiang Chen, Campbell, CA (US)

(73) Assignee: Apple Inc., Cupertino, CA (US)

(21) Appl. No.: 19/224,597

(22) Filed: May 30, 2025

(30) Foreign Application Priority Data
Jan. 31, 2025 (GR) 20250100066

(51) Int. Cl. H04W 24/08; H04W 24/02; H04W 28/06

(52) U.S. Cl. CPC H04W 24/08; H04W 24/02; H04W 28/06

(57) ABSTRACT

The present application relates to devices and components including apparatuses, systems, and methods for event detection associated with channel state information (CSI) compression.

### CROSS-REFERENCE TO RELATED APPLICATION

This application claims the benefit of Greece Patent Application Serial No. 20250100066, filed on Jan. 31, 2025, the contents of which are incorporated herein by reference in its entirety for all purposes.

### TECHNICAL FIELD

This application relates generally to communication networks and, in particular, to event detection for channel state information compression.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example procedure for network-side monitoring of channel state information (CSI) compression performance, in accordance with some embodiments herein.

FIG. 3 illustrates an example procedure for UE-side monitoring of CSI compression performance, in accordance with some embodiments herein.

FIG. 4 illustrates an example system for event detection in accordance with some embodiments.

FIG. 5 illustrates an example procedure to support event detection associated with CSI compression, in accordance with some embodiments.

FIG. 6 illustrates an operational flow/algorithmic structure in accordance with some embodiments.

FIG. 7 illustrates another operational flow/algorithmic structure in accordance with some embodiments.

FIG. 8 illustrates another operational flow/algorithmic structure in accordance with some embodiments.

FIG. 9 illustrates a user equipment in accordance with some embodiments.

FIG. 10 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

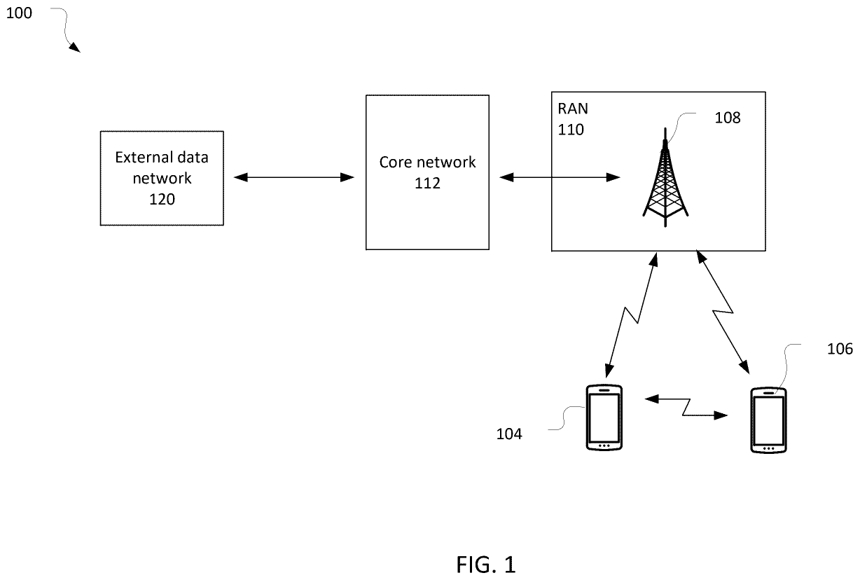

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system (e.g., Sixth Generation (6G) system). The base station 108 may provide user plane (UP) and control plane (CP) protocol terminations toward the UE 104.

The network environment 100 may further include a core network (CN) 112. For example, the CN 112 may comprise a 5th Generation Core network (5GC), a 6th Generation Core network (6GC), or later generation core network. The CN 112 may be coupled to the base station 108 via a fiber optic or wireless backhaul. The CN 112 may provide functions for the UE 104 via the base station 108. These functions may include managing subscriber profile information, subscriber location, authentication of services, or switching functions for voice and data sessions.

The network environment 100 may further include an external data network 120, which may be accessed by the UE 104 via the RAN 110.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

The UE 104 may generate channel state information (CSI) based on measurements on one or more reference signals transmitted by the RAN 110 (e.g., by the base station 108) and report the CSI to the RAN 110. The one or more reference signals may include, for example, a CSI-reference signal (CSI-RS) and/or a synchronization signal block (SSB, also referred to as a synchronization signal/physical broadcast channel (PBCH) block). The CSI may include, for example, a channel quality indicator (CQI), precoding matrix indicator (PMI), a CSI-RS resource indicator (CRI), a SSB resource indicator (SSBRI), layer indicator (LI), rank indicator (RI), layer 1 (L1) reference signal received power (RSRP), L1 signal-and-interference-to-noise ratio (SINR), a capability index, and/or time-domain properties.

In embodiments, the UE 104 may use an artificial intelligence (AI)/machine learning (ML) model to compress the CSI. The UE 104 may report the compressed CSI to the base station 108. The base station 108 may use a reconstruction model (e.g., an AI/ML model) to reconstruct the CSI based on the compressed CSI (referred to as recovery CSI or reconstructed CSI). The compressed CSI using the AI/ML model may enable more precise beamforming information and/or reduce signaling overhead compared to reporting uncompressed CSI.

The UE 104 and/or base station 108 may monitor performance of the CSI compression model, e.g., based on a key performance indicator (KPI). For example, the KPI may include a squared generalized cosine similarity (SGCS) between the recovery CSI and the uncompressed CSI (e.g., ground-truth CSI measurement). The SGCS may be a value between 0 and 1, with 1 representing that the recovery CSI perfectly corresponds to the uncompressed CSI and values closer to 0 indicating lower similarity between the recovery CSI and the uncompressed CSI.

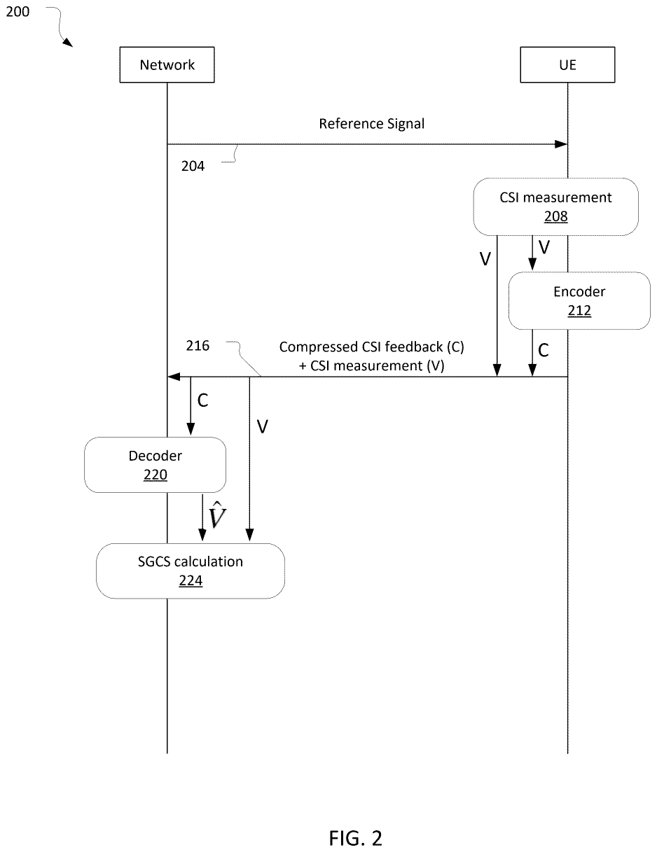

FIG. 2 illustrates an example procedure 200 for network-side monitoring of CSI compression performance. Aspects of the procedure 200 may be performed by a UE (e.g., UE 104) and/or a network (e.g., RAN 110, such as base station 108).

At 204 of the procedure 200, the UE may receive a reference signal from the network. The reference signal may include, for example, a CSI-RS and/or an SSB.

At 208 of the procedure 200, the UE may generate a CSI measurement (e.g. a ground-truth CSI measurement). For example, the CSI measurement may include one or more precoding vectors V. In an example, the precoding vectors V may correspond to an estimated channel H, e.g., where H=UΣV. For example, the precoding vectors V may be eigenvectors of the channel H.

At 212 of the procedure 200, an encoder may generate CSI feedback C based on the precoding vectors V. The encoder may use a trained AI/ML model (e.g., referred to as a CSI compression model) to generate the CSI feedback C. The CSI feedback C may be compressed, e.g., a latent space encoding of the precoding vectors V. While the procedure 200 is illustrated with the CSI feedback C being encoded from the precoding vectors V, in other embodiments the CSI feedback may be encoded from the channel H.

At 216, the CSI feedback C and the CSI measurement V may be transmitted to the network. In some embodiments, the CSI measurement V may be reported using an eT2-like high resolution codebook, which may provide more precise reporting than legacy eT2 codebook.

At 220 of the procedure 200, a decoder at the network-side (e.g., in the base station) may decode the compressed CSI feedback C to generate recovery CSI \hat{V} (also referred to as reconstructed CSI).

At 224 of the procedure 200, the network calculates the SGCS between the recovery CSI \hat{V} and the CSI measurement V. The SGCS may be indicative of how close the recovery CSI \hat{V} is to the CSI measurement V and thus how accurate the CSI compression model (e.g., including encoding and/or decoding) is. In some embodiments, another intermediate KPI may be used in addition to or instead of SGCS, such as normalized mean square error (NMSE).

The network may identify one or more issues (e.g., data drift, model degradation, hardware faults) and/or take one or more actions (e.g., retraining the CSI compression model, reconfiguring the CSI compression model, switching the CSI compression model to a different model, and/or deactivating the CSI compression model) based on the SGCS.

In an example, the SGCS may correspond to:

$$p ( W , {W}^{′} ) = \frac{1}{\vert W \vert {N}_{sb}} {\sum }_{i = 1}^{\vert W \vert} {\sum }_{k = 1}^{{N}_{sb}} {( \frac{‖ {w}_{k , i}^{H} {w}_{k , i}^{′} ‖ 2}{‖ {w}_{k , i} ‖ 2 ‖ {w}_{k , i}^{′} ‖ 2} )}^{2}$$

where W corresponds to the vector of CSI measurement V, W′ corresponds to the vector of recovery CSI \hat{V}, and/or N_{sb} corresponds to a number of subbands associated with the CSI.

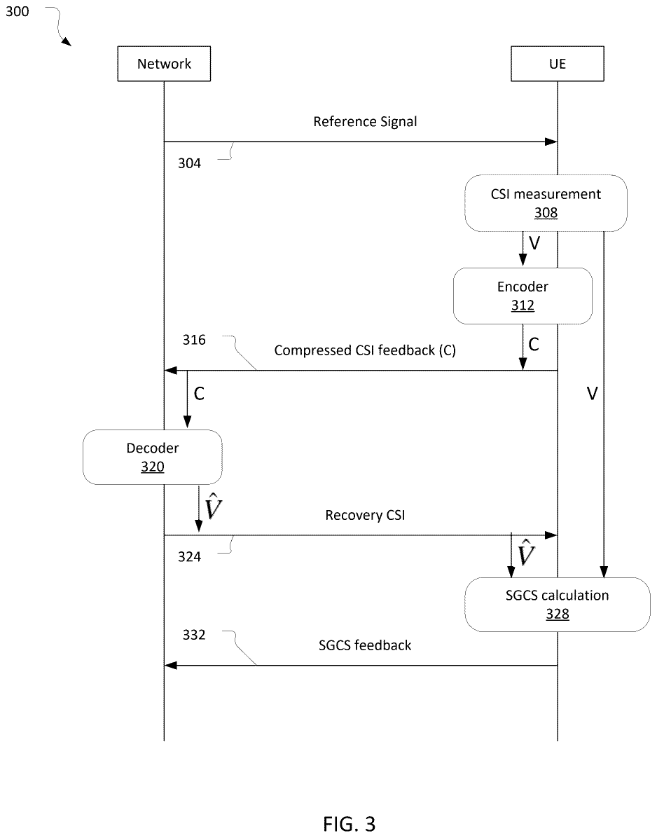

FIG. 3 illustrates an example procedure 300 for UE-side monitoring of CSI compression performance. Aspects of the procedure 200 may be performed by a UE (e.g., UE 104) and/or a network (e.g., RAN 110, such as base station 108).

Operations 304, 308, and 312 of procedure 300 may be similar to respective operations 204, 208, and 212 of procedure 200. For example, the UE may receive a reference signal at 304 and generate a CSI measurement V (e.g., a ground-truth CSI measurement) at 308. At 312, the UE may use an AI/ML trained encoder (e.g., employing a CSI compression model) to generate compressed CSI feedback C based on the CSI measurement V. The compressed CSI feedback C may be a latent space representation of CSI measurement V.

At 316 of the procedure 300, the UE may transmit the compressed CSI feedback C to the network. The UE may not transmit the CSI measurement V to the network, since the monitoring of the CSI compression performance is performed at the UE side.

At 320, the network may decode the compressed CSI feedback C to generate recovery CSI \hat{V}. At 324, the network may transmit the recovery CSI \hat{V} to the UE. At 328, the UE may calculate the SGCS (or another intermediate KPI) based on the recovery CSI \hat{V} and the CSI measurement V. At 332, the UE may report the SGCS to the network.

As with the procedure 200, the network may identify one or more issues (e.g., data drift, model degradation, hardware faults) and/or take one or more actions (e.g., retraining the CSI compression model, reconfiguring the CSI compression model, switching the CSI compression model to a different model, and/or deactivating the CSI compression model) based on the SGCS.

However, additional mechanisms may be needed to evaluate whether the monitoring procedure is accurate (e.g., accurately identifies issues and/or appropriate actions). It has been proposed to compute an SGCS accuracy for model monitoring by averaging the per-sample difference between a genie SGCS and a calculated SGCS based on ground-truth reporting and SGCS estimation (e.g., E[|SGCS_{genie}−SGCS_{measured}|]). However, while this metric reflects the accuracy of the SGCS calculation, it fails to reflect the performance of decision-making processes (e.g., identification of issues with the model and/or appropriate actions) that are important for monitoring of CSI compression performance.

For example, a CSI compression model may be trained for a particular environment (e.g., including a set of propagation conditions, such as type of channel, indoor/outdoor, line-of-sight (LoS) or non-LoS, etc.). The CSI compression model may generally have good performance within the trained environment (e.g., with SGCS values close to 1). However, the CSI compression model may or may not apply well to other environments. Furthermore, the SGCS value (or other KPI) may have a distribution of values across different samples within the same environment, thus making it difficult to get a reliable estimate of SGCS to make an event prediction.

Embodiments herein provide mechanisms to perform event detection for monitoring performance of a CSI compression model. The event detection may identify an issue with the CSI compression model and/or trigger an appropriate action. The event detection may identify and/or react to anomalies, model degradation, and/or environmental changes. In embodiments, the event detection may include direct event detection based on the compressed CSI (C) transmitted from the UE to the network and/or indirect event detection based on an intermediate KPI such as SGCS and/or another KPI.

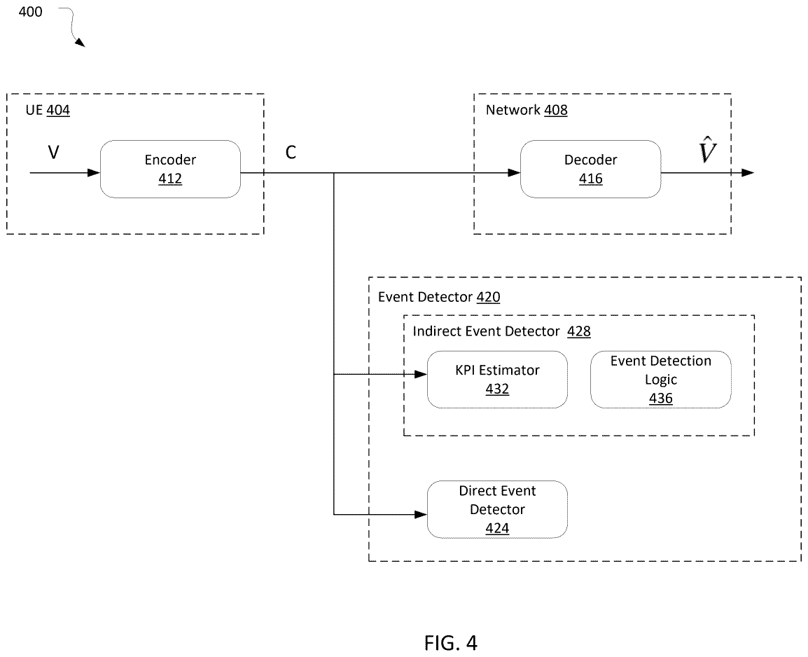

FIG. 4 illustrates an example of a system 400 for event detection in accordance with some embodiments. A UE 404 (e.g., corresponding to UE 104) may include an encoder 412 to generate compressed CSI (C), e.g., based on precoding vectors V and/or channel H as discussed above. The UE 404 may transmit the compressed CSI to the network 408 (e.g., corresponding to base station 108). A decoder 416 of the network 408 may generate recover CSI \hat{V} based on the received compressed CSI.

The system 400 may further include an event detector 420. The event detector 420 may be implemented in the UE 404, the network 408, and/or another device in communication with the UE 404 and/or network 408. The event detector 420 may include a direct event detector 424 and/or an indirect event detector 428. It is noted that some embodiments may include direct event detector 424 without indirect event detector 428, indirect event detector 428 without direct event detector 424, or both direct event detector 424 and indirect event detector 428.

The direct event detector 424 may receive the compressed CSI C and detect an event based directly on the compressed CSI C. For example, the direct event detector 424 may use an event detection model (e.g., an AI/ML model) to predict the occurrence of the event based on the compressed CSI C. The event may be, for example, data distribution drift, model degradation, hardware fault, environmental change, and/or anomalous behavior). The direct event detector 424 may additionally or alternatively recommend an action to resolve the event, such as retraining, reconfiguring, switching, and/or deactivating (e.g., reverting to legacy CSI reporting) the CSI compression model.

The indirect event detector 428 may include a KPI estimator 432 to estimate one or more KPIs based on the compressed CSI C. The KPI estimator 432 may estimate the one or more KPIs using a trained AI/ML model. The indirect event detector 432 may further include detection logic 436 to detect an event based on the one or more estimated KPIs. In some embodiments, the one or more estimated KPIs may include an estimated SGCS.

The direct event detector 424 and/or the indirect event detector 428 (e.g., the KPI estimator 432 and/or event detection logic 436) may be trained with training data. In some embodiments, the training data may include inputs with associated output labels. Individual inputs may include one or more compressed CSIs, such as a set of compressed CSIs over a time window. For example, the individual inputs may include a vector that corresponds to an observation window. The output labels may indicate whether an event should be detected for the associated input. For example, the output labels may be a binary classifier with a first value (e.g., logic 1) to indicate that an event is detected or a second value (e.g., logic 0) to indicate that an event is not detected. The output may indicate whether the event occurs within a prediction window, which may or may not overlap with the observation window (e.g., the prediction window may be after the observation window).

In some embodiments, the output labels may be based on one or more KPIs. For example, the one or more KPIs used for the output labels may include throughput-related KPIs, which may be representative of system performance and indicative of whether an event has occurred that requires action. The one or more throughput-related KPIs may include, for example, spectral efficiency, channel quality indicator (CQI), mutual information (e.g., an internal UE metric indicative of communication throughput), etc.

Not all environmental changes may lead to performance degradation. For example, a CSI compression model that is trained with a dataset associated with a first environment may still perform well in (e.g., generalize to) another environment for inference performance. In embodiments, it may be beneficial for the event detector 420 to not predict an event in this circumstance (e.g., to avoid the overhead involved in switching and/or retraining the model). The output labels of the training data being based on the one or more throughput-related KPIs may enable the event detector 420 to detect an event based on an associated (e.g., predicted) drop in performance rather than solely a change in environment.

In an example, an input of the training data may be assigned an output label of the first value (e.g., indicating an event is detected) if a drop in one or more (e.g., any or all) of the throughput-related KPIs is greater than a threshold within a time interval and/or if a value of one or more of the throughput-related KPIs is less than a threshold. Additionally, or alternatively, an input of the training data may be assigned an output label of the second value (e.g., indicating an event is not detected) if a drop in one or more (e.g., any or all) of the throughput-related KPIs is less than a threshold and/or if a value of one or more of the throughput-related KPIs is greater than a threshold.

In some embodiments, the output labels of the training data may be associated with specific types of events, such as data drift, model degradation, environment change, hardware fault, and/or an anomaly. This may enable the event detection model to detect a type of event. In other embodiments, the event detection model may detect occurrence of an event without distinguishing between different types of events.

In some embodiments, a model performance metric may be used to train and/or evaluate the event detection model of the event detector 420. For example, the model performance metric may include an F1 score, a precision metric, and/or a recall metric. In some embodiments, respective counters may be maintained based on whether the event detection model predicts an event and whether the event actually occurred (e.g., a “genie” result). Table 1 illustrates an example of the four counters, n0, n1, n2, and n3.

TABLE 1

| | Predicted Negative | Predicted Positive |
|---|---|---|
| Genie Negative | n0 | n1 |
| Genie Positive | n2 | n3 |

Counter n0 refers to the case where the event detection model does not predict an event and an event does not actually occur. Note that, in some embodiments, counter n0 may not be used in calculating a model performance metric. Accordingly, counter n0 may or may not be maintained during training of the event detection model.

Counter n1 refers to the case where the event detection model predicts an event but the event does not actually occur (e.g., a false alarm event prediction). Counter n2 refers to the case where the event detection model does not predict an event but the event does actually occur (e.g., a real event is missed by the model). Counter n3 refers to the case where the event detection model predicts an event and the event does actually occur (e.g., the model correctly predicts an event).

The precision metric may correspond to the number of true positives divided by the total number of predicted positives (e.g., n3/(n1+n3)). The precision metric indicates the proportion of predictions made by the model that are actually correct. Accordingly, the precision metric may measure how accurate the model is when it positively identifies an event.

The recall metric may correspond to the number of true positives divided by the total number of actual positives (e.g., n3/(n2+n3)). The recall metric may measure how well the model captures positive cases (also referred to as sensitivity or true positive rate), e.g., what percentage of all actual positive cases the model correctly predicted.

The F1 score may be a function of the precision metric and the recall metric. For example, the F1 score may be equal to 2*Precision*Recall/(Precision+Recall). Accordingly, the F1 score may be a single metric that combines the recall metric and the precision metric using the harmonic mean.

In some embodiments, the event detection model may be trained based on the F1 score, e.g., to optimize the F1 score. For example, the event detection model may be an AI/ML classifier model with weights adjusted based on the F1 score.

In some embodiments, online training may be performed on the event detection model while the event detection model is deployed (e.g., based on actual data). For example, the online training may be based on one or more throughput-related KPIs, which may be monitored by the UE on an ongoing basis. For example, the one or more throughput-related KPIs for online training may include instantaneous throughput, throughput trend analysis (e.g., short-term drops and/or spikes), and/or time-average throughput over a time window (e.g., a sliding window).

The online training may enable the event detection model to adapt to real-time changes, e.g., align the model with the current network conditions to provide more accurate event predictions. Additionally, the online training may continuously validate the model's predictions against actual throughput measurements.

In some embodiments, the UE may use a reinforcement learning (RL) framework in which the events and/or actions determined by the model receive feedback based on real-time throughput changes. The feedback may be used to update the model for future decisions. For example, one or more reward functions may be implemented for the model to incentivize maintaining or improving throughput.

In some embodiments, the output of the event detector may include a probability of an event (e.g., rather than a binary value indicating whether or not the event is predicted to occur). For example, the probability may correspond to a value of 0 to 1, with a value closer to one indicating higher probability that the event occurred and a value closer to zero indicating a lower probability that the event occurred. In other embodiments, the output of the event detector may be a binary value indicating whether or not the event is predicted to occur.

In embodiments, when the event detector is implemented at the UE, the UE may transmit an indication of a detected event to the network. For example, the indication of the detected event may be transmitted to a life cycle management (LCM) entity of the network, which may be implemented in a base station and/or in the core network. In some embodiments, the UE may indicate a recommended action based on the detected event (e.g., as recommended by the event detection model). In other embodiments, the network may determine the action to take based on the indication of the detected event received from the UE.

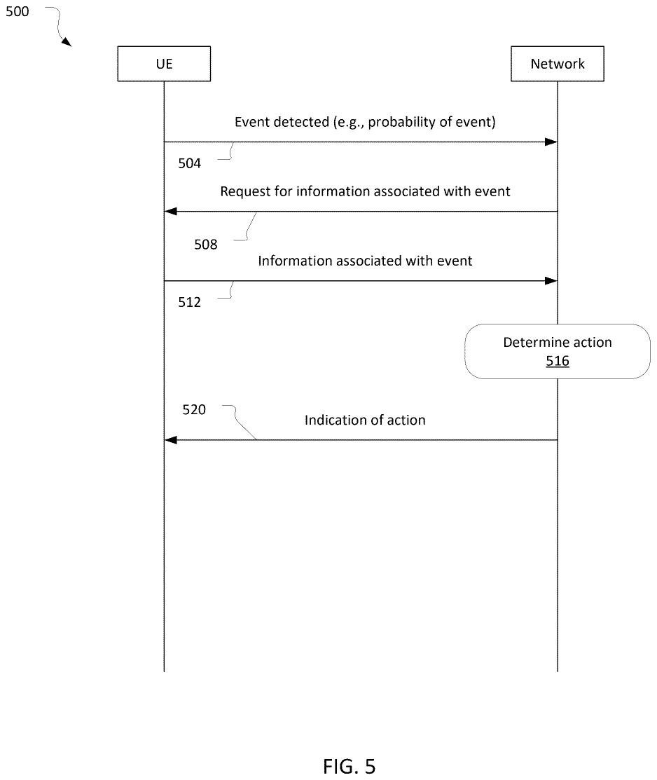

FIG. 5 illustrates an example procedure 500 to support event detection associated with CSI compression, in accordance with some embodiments. Aspects of the procedure 500 may be performed by a UE (e.g., UE 104) and/or a network (e.g., RAN 110 and/or base station 108), or components thereof. For example, the signaling of FIG. 5 may be used with the system 400 of FIG. 4. Note that, in some embodiments, one or more operations of procedure 500 may be omitted or modified. Additionally, some embodiments may include one or more additional operations as described herein.

In an example, at 504, the UE may transmit an indication of a detected event to the network. The indication may include a probability of the detected event and/or a binary value indicating whether or not the event is detected. In some embodiments, the indication may include an identifier of the event.

In some embodiments, at 508, the network may request information from the UE related to the event, such as one or more KPIs. The network may assign resources in which the UE is to provide the requested information. At 512, the UE may transmit the requested information to the network (e.g., in the assigned resources).

At 516, the network may determine an action to take based on the detected event and/or the additional information (e.g., KPIs) received from the UE at 512. In some embodiments, the determination of the action may be performed by an LCM entity of the network. For example, the action may include to reconfigure the CSI compression model, retrain the CSI compression model, switch to a different CSI compression model, and/or deactivate the CSI compression model (e.g., revert to legacy CSI reporting).

At 520, the network may transmit an indication of the action to the UE. In some embodiments, when the action includes to retrain the CSI compression model, the network may provide retraining information, such as information related to a retraining procedure, and/or a resource allocation for one or more reference signals (e.g., CSI-RS) used for retraining. When the action includes to switch to a different model, the network may indicate a model ID of the new model that is to be used for CSI compression. When the action includes to deactivate the current model (e.g., as part of the switch to a new model or reverting to legacy operation), the network may indicate the model ID of the current model that is to be deactivated.

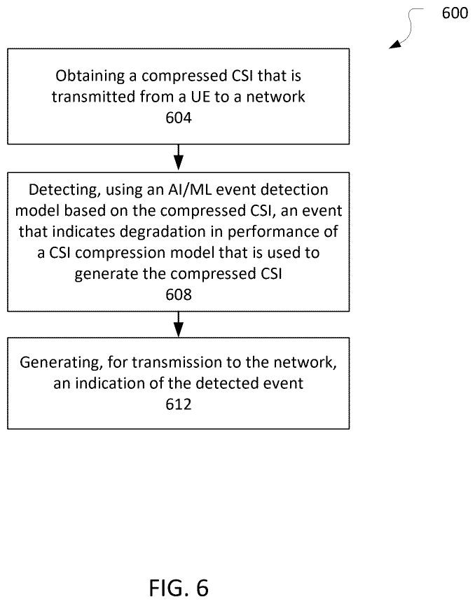

FIG. 6 illustrates an operational flow/algorithmic structure 600 in accordance with some embodiments. In some embodiments, the operational flow/algorithmic structure 600 may be implemented by a UE such as, for example, UE 104, UE 900, or components thereof, for example, processors 904A. In other embodiments, the operational flow/algorithmic structure 600 may be performed by another device (or components thereof), such as a base station (e.g., base station 108), another device of a RAN (e.g., RAN 110), or a device of a core network (e.g., core network 112).

The operational flow/algorithmic structure 600 may include, at 604, obtaining a compressed CSI that is transmitted from a UE to a network. For example, the compressed CSI may be encoded using a CSI compression model as discussed herein.

The operational flow/algorithmic structure 600 may further include, at 608, detecting, using an AI/ML event detection model based on the compressed CSI, an event that indicates degradation in performance of a CSI compression model that is used to generate the compressed CSI. The AI/ML event detection model may detect the event directly and/or indirectly based on the compressed CSI. In an example of indirect detection, the AI/ML event detection model may estimate one or more intermediate KPIs (e.g., SGCS) and detect the event based on the one or more intermediate KPIs. In some embodiments, the AI/ML event detection model may be trained with training data that is classified with associated output labels based on one or more throughput-related KPIs (e.g., spectral efficiency, CQI, etc.).

The operational flow/algorithmic structure 600 may further include, at 612, generating, for transmission to the network, an indication of the detected event. In some embodiments, the indication may indicate a probability of the event or a binary value indicating whether or not the event is detected. In some embodiments, the indication may indicate a type of the event (e.g., data drift, model degradation, hardware fault, environment change, and/or an anomaly).

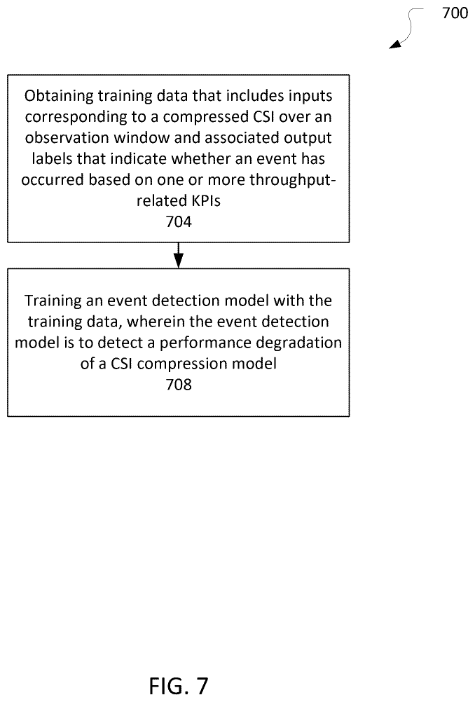

FIG. 7 illustrates another operational flow/algorithmic structure 700 in accordance with some embodiments. In some embodiments, the operational flow/algorithmic structure 700 may be implemented by a UE such as, for example, UE 104, UE 900, or components thereof, for example, processors 904A. In other embodiments, the operational flow/algorithmic structure 700 may be performed by another device (or components thereof), such as a base station (e.g., base station 108), another device of a RAN (e.g., RAN 110), or a device of a core network (e.g., core network 112).

The operational flow/algorithmic structure 700 may include, at 704, obtaining training data that includes inputs corresponding to a compressed CSI over an observation window and associated output labels that indicate whether an event has occurred based on one or more throughput-related key performance indicators (KPIs). The one or more throughput-related KPIs may include, for example, a spectral efficiency or a channel quality indicator. In some embodiments, the event detection model may be trained based further on a precision metric, a recall metric, and/or an F1 score (which may be based on the precision metric and the recall metric).

The operational flow/algorithmic structure 700 may further include, at 708, training an event detection model with the training data, wherein the event detection model is to detect a performance degradation of a CSI compression model. The performance degradation may include, for example, data drift, model degradation, hardware fault, environment change, and/or an anomaly.

In some embodiments, the operational flow/algorithmic structure 700 may further include obtaining one or more additional throughput-related KPIs while the event detection model is deployed, and performing online training of the event detection model based on the one or more additional throughput-related KPIs.

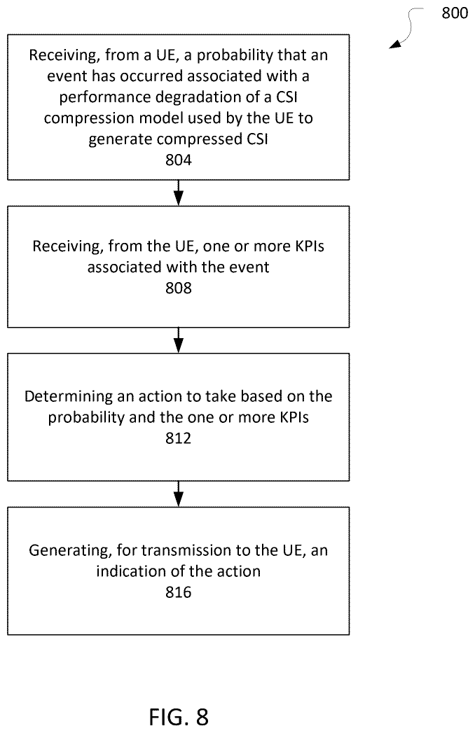

FIG. 8 illustrates another operational flow/algorithmic structure 800 in accordance with some embodiments. The operational flow/algorithmic structure 800 may be implemented by a network device such as, for example, a device of RAN 110 (e.g., base station 108), network device 1000, or components thereof, for example, processors 1004A.

The operational flow/algorithmic structure 800 may include, at 804, receiving, from a UE, a probability that an event has occurred associated with a performance degradation of a CSI compression model used by the UE to generate compressed CSI. In some embodiments, the network device may further receive, from the UE, an indication of a type of the event (e.g., data drift, model degradation, hardware fault, environment change, and/or an anomaly).

The operational flow/algorithmic structure 800 may further include, at 808, receiving, from the UE, one or more KPIs associated with the event. In some embodiments, the network device may generate, for transmission to the UE, a request for the one or more KPIs (e.g., based on receiving the probability that the event has occurred).

The operational flow/algorithmic structure 800 may further include, at 812, determining an action to take based on the probability and the one or more KPIs. For example, the action may include to retrain the CSI compression model, reconfigure the CSI compression model, switch to a different CSI compression model, or deactivate the CSI compression model.

The operational flow/algorithmic structure 800 may further include, at 816, generating, for transmission to the UE, an indication of the action.

In an example, when the action includes to retrain the CSI compression model, the network device may allocate reference signal resources to the UE for one or more reference signals to be used to retrain the CSI compression model.

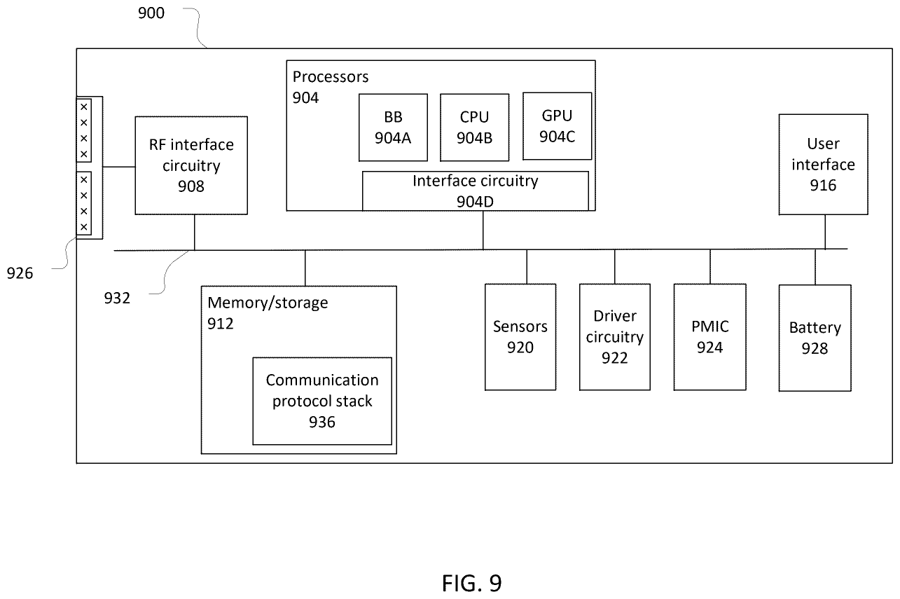

FIG. 9 illustrates a UE 900 in accordance with some embodiments. The UE 900 may be similar to and substantially interchangeable with UE 104 and/or UE 106.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 900 may include processors 904, RF interface circuitry 908, memory/storage 912, user interface 916, sensors 920, driver circuitry 922, power management integrated circuit (PMIC) 924, antenna 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein (e.g., operations associated with event detection for CSI compression). The processors 904 may also include interface circuitry 904D to enable communication by, for example, communicatively coupling the processor circuitry with one or more other components of the UE 900.

In some embodiments, the baseband processor 904A may access a communication protocol stack 936 in the memory/storage 912 to communicate over a 3GPP compatible network. In general, the baseband processor 904A may access the communication protocol stack 936 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 908.

The baseband processor 904A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform operations as described herein (e.g., operations associated with event detection for CSI compression).

The memory/storage 912 includes any type of volatile or non-volatile memory that may be distributed throughout the UE 900. In some embodiments, some of the memory/storage 912 may be located on the processors 904 themselves (for example, memory/storage 912 may be part of a chipset that corresponds to the baseband processor 904A), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensors 920 and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples the UE 900 may be mounted deployed in a fixed location and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

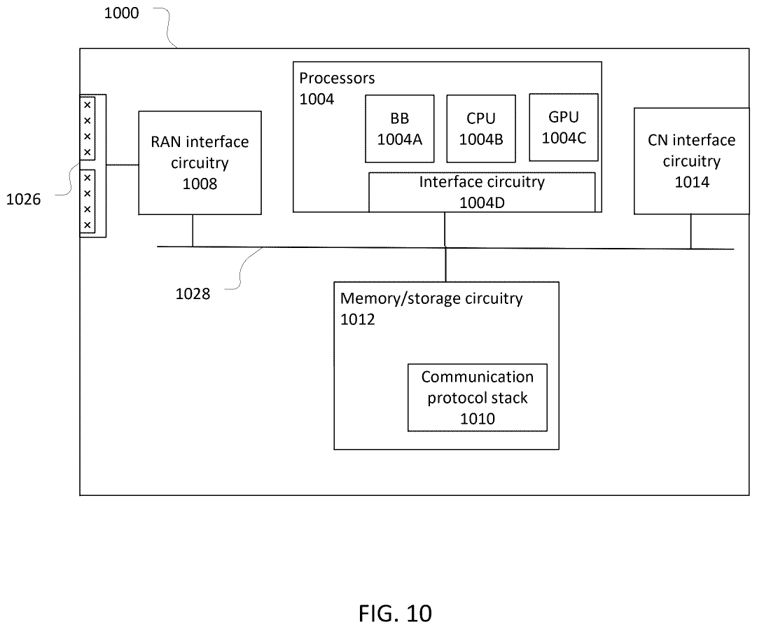

FIG. 10 illustrates a network device 1000 in accordance with some embodiments. The network device 1000 may be similar to, and substantially interchangeable with, the base station 108 and/or a component of the CN 112.

The network device 1000 may include processors 1004, RF interface circuitry 1008 (if implemented as a base station), core network (CN) interface circuitry 1014, memory/storage circuitry 1012, and antenna structure 1026.

The components of the network device 1000 may be coupled with various other components over one or more interconnects 1028.

The processors 1004, RF interface circuitry 1008, memory/storage circuitry 1012 (including communication protocol stack 1010), antenna structure 1026, and interconnects 1028 may be similar to like-named elements shown and described with respect to FIG. 9.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage circuitry 1012 to cause the network device 1000 to perform operations as described herein (e.g., operations associated with event detection for CSI compression). The processors 1004 may also include interface circuitry 1004D to communicatively couple the processor circuitry with one or more other components of the network device 1000.

The CN interface circuitry 1014 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1000 via a fiber optic or wireless backhaul. The CN interface circuitry 1014 may include one or more dedicated processors or FPGAs to communicate using one or more of the aforementioned protocols. In some implementations, the CN interface circuitry 1014 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

The following sections provide further exemplary embodiments are provided.

Example 1 includes a method comprising: obtaining a compressed channel state information (CSI) that is transmitted from a user equipment (UE) to a network; detecting, using an artificial intelligence (AI)/machine learning (ML) event detection model based on the compressed CSI, an event that indicates degradation in performance of a CSI compression model that is used to generate the compressed CSI; and generating, for transmission to the network, an indication of the detected event.

Example 2 includes the method of example 1 or some other example herein, wherein the AI/ML event detection model is to detect the event based directly on the compressed CSI.

Example 3 includes the method of example 1 or some other example herein, wherein, to detect the event, the AI/ML event detection model is to: estimate a key performance indicator (KPI) based on the compressed CSI; and detect the event based on the estimated KPI.

Example 4 includes the method of example 3 or some other example herein, wherein the KPI includes a squared generalized cosine similarity (SGCS) between an uncompressed CSI that corresponds to the compressed CSI and a recovery CSI that is decoded from the compressed CSI.

Example 5 includes the method of example 1 or some other example herein, wherein the AI/ML event detection model is trained with training data that is classified with associated output labels based on one or more throughput-related key performance indicators (KPIs).

Example 6 includes the method of example 1 or some other example herein, wherein the AI/ML event detection model is trained based on an F1 score, a precision metric, or a recall metric.

Example 7 includes the method of example 1 or some other example herein, further comprising: monitoring one or more throughput-related KPIs while the AI/ML event detection model is activated; and performing online training of the AI/ML event detection model based on the one or more throughput-related KPIs.

Example 8 includes the method of example 1 or some other example herein, wherein the AI/ML event detection model is implemented by the UE.

Example 9 includes the method of example 1 or some other example herein, further comprising: receiving, from the network, a request for information associated with the event, wherein the information includes one or more key performance indicators (KPIs); and generating, for transmission to the network, a message that includes the one or more KPIs.

Example 10 includes the method of example 1 or some other example herein, wherein the indication of the event indicates a type of the event, wherein the type includes data drift, model degradation, or environment change.

Example 11 includes the method of example 1 or some other example herein, further comprising receiving, from the network, an indication of an action to take based on the event, wherein the action includes to retrain the CSI compression model, reconfigure the CSI compression model, switch to a different CSI compression model, or deactivate the CSI compression model.

Example 12 includes one or more computer-readable media having instructions that, when executed, cause processing circuitry to: obtain training data that includes inputs corresponding to a compressed channel state information (CSI) over an observation window and associated output labels that indicate whether an event has occurred based on one or more throughput-related key performance indicators (KPIs); and train an event detection model with the training data, wherein the event detection model is to detect a performance degradation of a CSI compression model.

Example 13 includes the one or more computer-readable media of example 12 or some other example herein, wherein the one or more throughput-related KPIs include a spectral efficiency or a channel quality indicator.

Example 14 includes the one or more computer-readable media of example 12 or some other example herein, wherein the instructions, when executed, further cause the processing circuitry to train the event detection model based further on an F1 score, a precision metric, or a recall metric.

Example 15 includes the one or more computer-readable media of example 12 or some other example herein, wherein to detect the performance degradation includes to detect data drift, model degradation, or environment change.

Example 16 includes the one or more computer-readable media of example 12 or some other example herein, wherein the instructions, when executed, further cause the processing circuitry to: obtain one or more additional throughput-related KPIs while the event detection model is deployed; and perform online training of the event detection model based on the one or more additional throughput-related KPIs.

Example 17 includes a method comprising: receiving, from a user equipment (UE), a probability that an event has occurred associated with a performance degradation of a channel state information (CSI) compression model used by the UE to generate compressed CSI; receiving, from the UE, one or more key performance indicators (KPIs) associated with the event; determining an action to take based on the probability and the one or more KPIs, wherein the action includes to retrain the CSI compression model, reconfigure the CSI compression model, switch to a different CSI compression model, or deactivate the CSI compression model; and generating, for transmission to the UE, an indication of the action.

Example 18 includes the method of example 17 or some other example herein, further comprising generating, for transmission to the UE, a request for the one or more KPIs.

Example 19 includes the method of example 17 or some other example herein, wherein the action includes to retrain the CSI compression model, and wherein the method further comprises allocating reference signal resources to the UE for one or more reference signals to be used to retrain the CSI compression model.

Example 20 includes the method of example 17 or some other example herein, further comprising receiving, from the UE, an indication of a type of the event, wherein the type includes data drift, model degradation, or environment change.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
obtaining a compressed channel state information (CSI) that is transmitted from a user equipment (UE) to a network;
detecting, using an artificial intelligence (AI)/machine learning (ML) event detection model based on the compressed CSI, an event that indicates degradation in performance of a CSI compression model that is used to generate the compressed CSI; and
generating, for transmission to the network, an indication of the detected event.

2. The method of claim 1, wherein the AI/ML event detection model is to detect the event based directly on the compressed CSI.

3. The method of claim 1, wherein, to detect the event, the AI/ML event detection model is to:
estimate a key performance indicator (KPI) based on the compressed CSI; and
detect the event based on the estimated KPI.

4. The method of claim 3, wherein the KPI includes a squared generalized cosine similarity (SGCS) between an uncompressed CSI that corresponds to the compressed CSI and a recovery CSI that is decoded from the compressed CSI.

5. The method of claim 1, wherein the AI/ML event detection model is trained with training data that is classified with associated output labels based on one or more throughput-related key performance indicators (KPIs).

6. The method of claim 1, wherein the AI/ML event detection model is trained based on an F1 score, a precision metric, or a recall metric.

7. The method of claim 1, further comprising:
monitoring one or more throughput-related KPIs while the AI/ML event detection model is activated; and
performing online training of the AI/ML event detection model based on the one or more throughput-related KPIs.

8. The method of claim 1, wherein the AI/ML event detection model is implemented by the UE.

9. The method of claim 1, further comprising:
receiving, from the network, a request for information associated with the event, wherein the information includes one or more key performance indicators (KPIs); and
generating, for transmission to the network, a message that includes the one or more KPIs.

10. The method of claim 1, wherein the indication of the event indicates a type of the event, wherein the type includes data drift, model degradation, or environment change.

11. The method of claim 1, further comprising receiving, from the network, an indication of an action to take based on the event, wherein the action includes to retrain the CSI compression model, reconfigure the CSI compression model, switch to a different CSI compression model, or deactivate the CSI compression model.

12. One or more non-transitory, computer-readable media having instructions that, when executed, cause processing circuitry to:
obtain training data that includes inputs corresponding to a compressed channel state information (CSI) over an observation window and associated output labels that indicate whether an event has occurred based on one or more throughput-related key performance indicators (KPIs); and
train an event detection model with the training data, wherein the event detection model is to detect a performance degradation of a CSI compression model.

13. The one or more non-transitory, computer-readable media of claim 12, wherein the one or more throughput-related KPIs include a spectral efficiency or a channel quality indicator.

14. The one or more non-transitory, computer-readable media of claim 12, wherein the instructions, when executed, further cause the processing circuitry to train the event detection model based further on an F1 score, a precision metric, or a recall metric.

15. The one or more non-transitory, computer-readable media of claim 12, wherein to detect the performance degradation includes to detect data drift, model degradation, or environment change.

16. The one or more non-transitory, computer-readable media of claim 12, wherein the instructions, when executed, further cause the processing circuitry to:
obtain one or more additional throughput-related KPIs while the event detection model is deployed; and
perform online training of the event detection model based on the one or more additional throughput-related KPIs.

17. A method comprising:
receiving, from a user equipment (UE), a probability that an event has occurred associated with a performance degradation of a channel state information (CSI) compression model used by the UE to generate compressed CSI;
receiving, from the UE, one or more key performance indicators (KPIs) associated with the event;
determining an action to take based on the probability and the one or more KPIs, wherein the action includes to retrain the CSI compression model, reconfigure the CSI compression model, switch to a different CSI compression model, or deactivate the CSI compression model; and
generating, for transmission to the UE, an indication of the action.

18. The method of claim 17, further comprising generating, for transmission to the UE, a request for the one or more KPIs.

19. The method of claim 17, wherein the action includes to retrain the CSI compression model, and wherein the method further comprises allocating reference signal resources to the UE for one or more reference signals to be used to retrain the CSI compression model.

20. The method of claim 17, further comprising receiving, from the UE, an indication of a type of the event, wherein the type includes data drift, model degradation, or environment change.
